(19) United States
(12) Patent Application Publication
(10) Pub. No.: US 2019/0347377 A1
(43) Pub. Date: Nov. 14, 2019

(54) ALGAN/GAN HEMT SMALL-SIGNAL MODEL AND METHOD FOR EXTRACTING PARAMETERS THEREOF

(71) Applicants: China Communication Microelectronics Technology Co., Ltd., Shenzhen, Guangdong (CN); Shenzhen Institute of Terahertz Technology and Innovation Co., Ltd., Shenzhen, Guangdong (CN)

(72) Inventors: Guangsheng WU, Shenzhen, Guangdong (CN); Haifeng ZHOU, Shenzhen, Guangdong (CN); Ging DiNG, Shenzhen, Guangdong (CN); Xiaocong LI, Shenzhen, Guangdong (CN); Jiaila WANG, Shenzhen, Guangdong (CN)

(21) Appl. No.: 16/474,162

(22) PCT Filed: Dec. 25, 2017
(86) PCT No.: PCT/CN2017/118357

§ 371 Date: Jun. 27, 2019

(30) Foreign Application Priority Data
Dec. 27, 2016 (CN) 201611228985.9

(51) Int. Cl. G06F 17/50

(52) U.S. Cl. CPC G06F 17/5036; G06F 17/5068

(57) ABSTRACT

The invention relates to an AlGaN/GaN HEMT small-signal model and a method for extracting parameters thereof. According to the AlGaN/GaN HEMT small-signal model of the invention, based on a conventional AlGaN/GaN HEMT small-signal model, a first coplanar waveguide capacitor (I) between a gate and a source and a second coplanar waveguide capacitor (II) between the gate and a drain are added in a parasitic unit. Since an AlGaN/GaN HEMT device and a coplanar waveguide device have similar structures, by introducing the first coplanar waveguide capacitor (I) and the second coplanar waveguide capacitor (II) under a high-frequency condition, that is, considering the fact that the coplanar waveguide effect of the AlGaN/GaN HEMT device will introduce additional parasitic capacitances, the working state and device characteristics of the AlGaN/GaN HEMT device can be reflected more accurately, and the accuracy of the device model is improved.

### TECHNICAL FIELD

The invention relates to the technical field of integrated circuits, in particular to an AlGaN/GaN HEMT small-signal model and a method for extracting parameters thereof.

### BACKGROUND

Microwave devices and circuits are the important development direction of semiconductor technology today, and have been widely used in the national defense and civilian fields. With the development of communication technology, the importance of microwave devices and circuits increases day by day. A monolithic microwave integrated circuit (MMIC) based on AlGaN/GaN HEMTs devices already has a good performance index. AlGaN/GaN HEMT is widely used in microwave circuits due to its obvious advantages such as high working frequency, high power density, high power-added efficiency, good linearity, high input impedance, easy matching, and high temperature resistance.

The design of microwave monolithic integrated circuits based on AlGaN/GaN HEMTs devices, such as amplifiers, oscillators and mixers, all require accurate device models, which cannot be realized without device modeling. Device modeling is critical in the design process of microwave integrated circuits (MMIC), and is helpful for fast, accurate and flexible simulation of the designed circuits. At present, many equivalent circuit models and extraction methods of model parameters are proposed to facilitate the simulation of a device, of which a model proposed by Dambrine is the most classic. An equivalent circuit model is shown in FIG. 1, wherein the parameters in the dashed box are the intrinsic parameters of the device, including transconductance, channel on-resistance, and gate-source capacitance, and the intrinsic parameters vary with the bias voltage of the device. The parameters outside the dashed box are parasitic parameters, including parasitic inductance, mutual capacitance and contact resistance. The parasitic parameters are caused by a gate electrode, a source electrode and a drain electrode of the device and do not change with the bias voltage of the device.

Although the Dambrine model is very classic and has a mature method for extracting parameters, since the AlGaN/GaN HEMT device is widely used in high frequency fields, when the device works at very high frequencies, the size of the device is comparable to the wavelength, the gate-source and gate-drain metal electrodes are equivalent to coplanar waveguide transmission lines, and the coplanar waveguide capacitance thereof has a great influence on the device operating at high frequencies. A traditional small-signal model cannot well characterize the working state and device characteristics of the device at high frequencies.

### SUMMARY

In view of the above problems, it is necessary to provide an AlGaN/GaN HEMT small-signal model and a method for extracting parameters thereof. The small-signal model can work under a high-frequency condition, accurately reflect the working state of a device, and provide the accuracy of the small-signal model.

An AlGaN/GaN HEMT small-signal model comprises an intrinsic unit and a parasitic unit, wherein the parasitic unit comprises a first coplanar waveguide capacitor C_{gs}^{cpw} between a gate and a source and a second coplanar waveguide capacitor C_{gd}^{cpw} between the gate and a drain.

A first end of the intrinsic unit is connected with a gate terminal, a second end of the intrinsic unit is connected with a drain terminal, and a third end of the intrinsic unit is connected with a source terminal.

The first coplanar waveguide capacitor C_{gs}^{cpw} is connected in series between the first end and the third end of the intrinsic unit, and the second coplanar waveguide capacitor C_{gd}^{cpw} is connected in series between the first end and the second end of the intrinsic unit.

According to the AlGaN/GaN HEMT small-signal model, based on a conventional AlGaN/GaN HEMT small-signal model, the first coplanar waveguide capacitor C_{gs}^{cpw} between the gate and the source and the second coplanar waveguide capacitor C_{gd}^{cpw} between the gate and the drain are added in the parasitic unit. Since an AlGaN/GaN HEMT device and a coplanar waveguide device have similar structures, by introducing the first coplanar waveguide capacitor C_{gs}^{cpw} and the second coplanar waveguide capacitor C_{gd}^{cpw} under a high-frequency condition, that is, considering the fact that the coplanar waveguide effect of the AlGaN/GaN HEMT device will introduce additional parasitic capacitances, the working state and device characteristics of the AlGaN/GaN HEMT device can be reflected more accurately, and the accuracy of the device model is improved.

In one embodiment, the parasitic unit further comprises a gate parasitic inductor L_{g}, a source parasitic inductor Lₛ, a drain parasitic inductor L_{d}, a gate parasitic resistor R_{g}, a source parasitic resistor Rₛ, a drain parasitic resistor R_{d}, a gate PAD parasitic capacitor C_{pg}, and a drain PAD parasitic capacitor C_{pd}; the first end of the intrinsic unit is connected with the gate terminal via the gate parasitic resistor R_{g} and the gate parasitic inductor L_{g}; the second end of the intrinsic unit is connected with the drain terminal through the drain parasitic inductor L_{d} and the drain parasitic inductor R_{d}; and the third end of the intrinsic unit is connected with the source terminal through the source parasitic resistor Rₛ and the source parasitic inductor Lₛ.

A first end of the first coplanar waveguide capacitor C_{gs}^{cpw} is connected with a common end of the gate parasitic resistor R_{g} and the gate parasitic inductor L_{g}; and a second end of the first coplanar waveguide capacitor C_{gs}^{cpw} is connected with a common end of the source parasitic resistor Rₛ and the source parasitic inductor Lₛ.

A first end of the second coplanar waveguide capacitor C_{gd}^{cpw} is connected with the first end of the first coplanar waveguide capacitor C_{gs}^{cpw}; and a second end of the second coplanar waveguide capacitor is connected with a common end of the drain parasitic resistor L_{d} and the drain parasitic inductor R_{d}.

The gate PAD parasitic capacitor C_{pg} is connected in series between the gate terminal and the source terminal, and the drain PAD parasitic capacitor C_{pd} is connected in series between the drain terminal and the source terminal.

In one embodiment, the intrinsic unit comprises a gate-source intrinsic capacitor C_{gs}, a gate-drain intrinsic capacitor C_{gd}, a drain-source intrinsic capacitor C_{ds}, an intrinsic channel resistor Rᵢ, a gate-drain leakage resistor R_{fd}, a gate-source leakage resistor R_{fs}, a drain-source resistor R_{ds}, a gate-drain resistor R_{gd}, and a transconductor gₘ; wherein,

the gate-source intrinsic capacitor C_{gs} and the intrinsic channel resistor Rᵢ are connected in series and then connected in parallel with the gate-source leakage resistor R_{fs} to form a first parallel circuit, a first end of the first parallel circuit is the first end of the intrinsic unit, and a second end of the first parallel circuit is grounded;

the gate-drain intrinsic capacitor C_{gd} is connected in parallel with the gate-drain leakage resistor R_{fd} and then connected in series with the gate-drain resistor R_{gd}, and one end, away from the gate-drain resistor R_{gd}, of the gate-drain intrinsic capacitor C_{gd} is connected with the first end of the first parallel circuit; and

the transconductor gₘ, the drain-source resistor R_{ds} and the drain-source intrinsic capacitor C_{ds} are connected in parallel to form a second parallel circuit, a first end of the second parallel circuit is connected with the gate-drain resistor R_{gd} and serves as the second end of the intrinsic unit, and a second end of the second parallel circuit is grounded.

Further, the invention provides a method for extracting parameters of the AlGaN/GaN HEMT small-signal model, comprising:

testing an S parameter of the AlGaN/GaN HEMT device under a first condition, converting the S parameter into a Y parameter, and acquiring parasitic capacitances according to the Y parameter, wherein the parasitic capacitances include a first coplanar waveguide capacitance C_{gs}^{cpw} between the gate and the source, a second coplanar waveguide capacitance C_{gd}^{cpw} between the gate and the drain, a gate PAD parasitic capacitance C_{pg}, and a drain PAD parasitic capacitance C_{pd}, and the value of the first coplanar waveguide capacitance C_{gs}^{cpw} is larger than the value of the drain PAD parasitic capacitance C_{pd};

testing the S parameter of the AlGaN/GaN HEMT device under a second condition, converting the S parameter into a Z parameter, and acquiring parasitic resistances according to a real part of the Z parameter, wherein the parasitic resistances include a gate parasitic resistance R_{g}, a source parasitic resistance Rₛ and a drain parasitic resistance R_{d};

acquiring parasitic inductances according to an imaginary part of the Z parameter, wherein the parasitic inductances include a gate parasitic inductance L_{g}, a source parasitic inductance Lₛ and a drain parasitic inductance L_{d}; and

testing the S parameter of the AlGaN/GaN HEMT device under a third condition, de-embedding the S parameter to obtain an intrinsic Y parameter, and acquiring intrinsic parameters according to the intrinsic Y parameter, wherein the intrinsic parameters include a gate-source intrinsic capacitance C_{gs}, a gate-drain intrinsic capacitance C_{gd}, a drain-source intrinsic capacitance C_{ds}, a transconductance gₘ, a transconductance delay factor τ, an intrinsic channel resistance Rᵢ, a gate-drain leakage resistance R_{fd}, a gate-source leakage resistance R_{fs}, a drain-source resistance R_{ds}, and a gate-drain resistance R_{gd}.

In one embodiment, the first condition is that a channel of the AlGaN/GaN HEMT device is completely turned off under a low-frequency test condition, V_{gs}<Vₚ, V_{ds}=0;

the second condition is that the channel of the AlGaN/GaN HEMT device is turned on under a high-frequency test condition, V_{gs}=Vₚ, V_{ds}=0; and

the third condition is a forward bias condition of V_{gs}<0V, V_{ds}>0, wherein

V_{gs} represents gate-source voltage, Vₚ represents pinch-off voltage, and V_{ds} represents source-drain voltage.

In one embodiment, the step of converting the S parameter into the Y parameter and acquiring the parasitic capacitances according to the Y parameter specifically comprises:

converting the S parameter into the Y parameter according to the following formula:

Im(Y₁₁)=ω(C_{pg}+C_{gs}^{cpw}+C_{gs}+C_{gd}+C_{gd}^{cpw})

Im(Y₁₂)=−ω(C_{gd}+C_{gd}^{cpw})

Im(Y₂₂)=ω(C_{pd}+C_{ds}+C_{gd}+C_{gd}^{cpw})

wherein ω represents angular frequency and −C_{gs}=C_{gd}, C_{gs}^{cpw}=3C_{pd}; and

acquiring the parasitic capacitances according to the Y parameter.

In one embodiment, the step of converting the S parameter into the Z parameter, and acquiring the parasitic resistances according to the real part of the Z parameter specifically comprises:

converting the S parameter into the Z parameter according to the following formula:

Z₁₁=Rₛ+R_{g}+Rⱼ+½R_{c}+jω(Lₛ+L_{g})

Z₁₂=Z₂₁=Rₛ+½R_{c}+jωLₛ

Z₂₂=Rₛ+R_{d}+R_{c}++jω(Lₛ+L_{d});

wherein Rⱼ represents gate-drain leakage resistance R_{fd} and gate-source leakage resistance R_{fs}, R_{c} represents the sum of channel resistances, ω represents angular frequency, and Rⱼ and R_{c} are ignored when the device is in a cut-off region; and

acquiring the parasitic resistances according to the real part of the Z parameter.

In one embodiment, the method further comprises the step of acquiring the parasitic inductances according to the imaginary part of the Z parameter.

In one embodiment, the step of de-embedding the S parameter to obtain the intrinsic Y parameter and acquiring the intrinsic parameters according to the intrinsic Y parameter specifically comprises:

de-embedding the S parameter to obtain the intrinsic Y parameter according to the following formula:

$${Y}_{11 i} = {G}_{fs} + {G}_{fd} + \frac{{ω}^{2} {R}_{i} {C}_{gs}^{2}}{{D}_{1}} + \frac{{ω}^{2} {R}_{gd} {C}_{gd}^{2}}{{D}_{2}} + j ω ( \frac{{C}_{gs}}{{D}_{1}} + \frac{{C}_{gd}}{{D}_{2}} )$$

$${Y}_{12 i} = - ( {G}_{fd} + \frac{{ω}^{2} {R}_{gd} {C}_{gd}^{2}}{{D}_{2}} + j ω \frac{{C}_{gd}}{{D}_{2}} )$$

$${Y}_{21 i} = - ( {G}_{fd} + \frac{{G}_{m} {e}^{- j ω τ}}{1 + j ω {R}_{i} {C}_{gs}} + j ω \frac{{C}_{gd}}{1 + j ω {R}_{gd} {C}_{gd}} )$$

$${Y}_{22 i} = {G}_{fd} + {G}_{ds} + \frac{{ω}^{2} {R}_{gd} {C}_{gd}^{2}}{{D}_{2}} + j ω ( {G}_{ds} + \frac{{C}_{gd}}{{D}_{2}} )$$

$$wherein {D}_{1} = 1 + {ω}^{2} {R}_{i} {C}_{gs}^{2} , \\ {D}_{2} = 1 + {ω}^{2} {R}_{gd}^{2} {C}_{gd}^{2} , \\ {G}_{fs} = \frac{1}{{R}_{fs}} , \\ {G}_{fd} = \frac{1}{{R}_{fd}} ,$$

and ω represents angular frequency; and

acquiring the intrinsic parameters according to a real part and an imaginary part of the intrinsic Y parameter.

In one embodiment, the method further comprises:

verifying the S parameter of the AlGaN/GaN HEMT device.

### BRIEF DESCRIPTION OF THE DRAWINGS

FIG. 1 is a model diagram of a conventional HEMT equivalent circuit;

FIG. 2 is an equivalent circuit diagram of an AlGaN/GaN HEMT small-signal model in one embodiment;

FIG. 3 is a schematic diagram of an AlGaN/GaN HEMT device in one embodiment;

FIG. 4 is an S parameter spectrum of an AlGaN/GaN HEMT device;

FIG. 5 is an S parameter spectrum of a simulated AlGaN/GaN HEMT small-signal model;

FIG. 6 is a flowchart of a method for extracting parameters of an AlGaN/GaN HEMT small-signal model in an embodiment;

FIG. 7 is an equivalent circuit diagram when a channel of an AlGaN/GaN HEMT device is completely turned off in one embodiment; and

FIG. 8 is an equivalent circuit diagram when a channel of an AlGaN/GaN HEMT device is turned on in one embodiment.

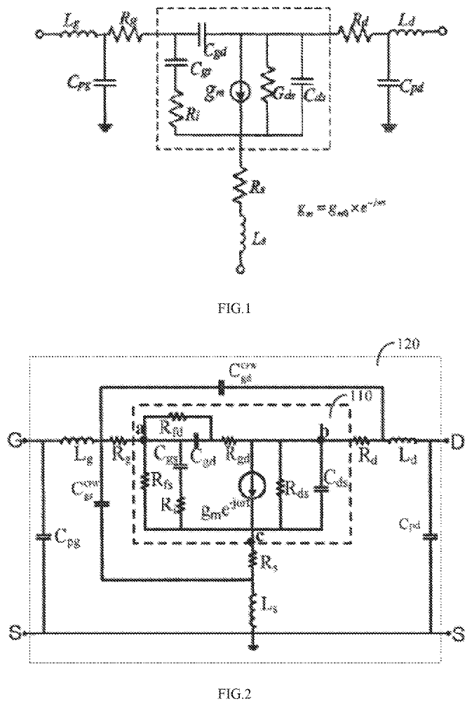

### DETAILED DESCRIPTION

In order to facilitate the understanding of the present invention, the present invention will be described more fully below with reference to the relevant drawings. Preferred embodiments of the present invention are shown in the accompanying drawings. However, the present invention may be implemented in many different forms and is not limited to the embodiments described herein. On the contrary, the purpose of providing these embodiments is to make the disclosure of the present invention more thorough and complete.

Unless otherwise defined, all technical and scientific terms used herein have the same meaning as commonly understood by those skilled in the technical field of the present invention. The terms used herein in the description of the present invention are for the purpose of describing specific embodiments only and are not intended to limit the present invention. As used herein, the term “and/or” includes any and all combinations of one or more related listed items.

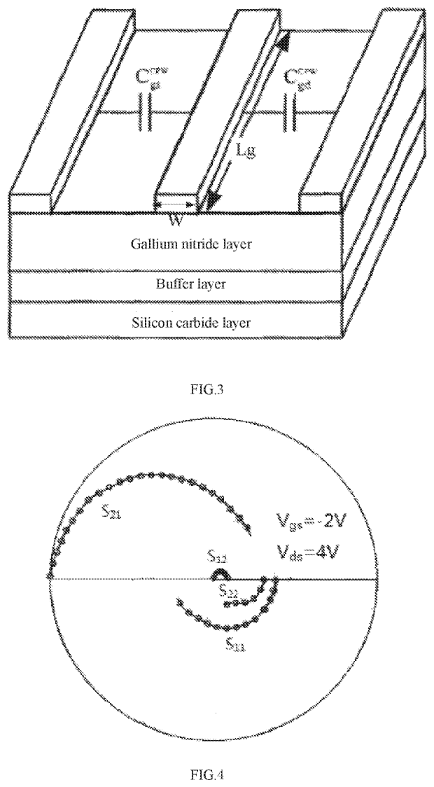

FIG. 2 is an equivalent circuit diagram of an AlGaN/GaN HEMT small-signal model in one embodiment, and FIG. 3 shows a device structure corresponding to an AlGaN/GaN HEMT small-signal model. The following specific example is to explain an equivalent circuit using the device structure and a parameter extraction method. The AlGaN/GaN HEMT small-signal model comprises an intrinsic unit 110 and a parasitic unit 120, wherein the parasitic unit 120 comprises a first coplanar waveguide capacitor C_{gs}^{cpw} between a gate and a source and a second coplanar waveguide capacitor C_{gd}^{cpw} between the gate and a drain. A first end a of the intrinsic unit 110 is connected with a gate terminal, a second end b of the intrinsic unit 110 is connected with a drain terminal, and a third end c of the intrinsic unit 110 is connected with a source terminal. The first coplanar waveguide capacitor is connected in series between the first end a and the third end of the intrinsic unit 110, and the second coplanar waveguide capacitor is connected in series between the first end a and the second end of the intrinsic unit 110.

According to the AlGaN/GaN HEMT small-signal model, based on a conventional AlGaN/GaN HEMT small-signal model, the first coplanar waveguide capacitor C_{gs}^{cpw} between the gate and the source and the second coplanar waveguide capacitor C_{gd}^{cpw} between the gate and the drain are added in the parasitic unit 120. Since an AlGaN/GaN HEMT device and a coplanar waveguide device have similar structures, by introducing the first coplanar waveguide capacitor C_{gs}^{cpw} and the second coplanar waveguide capacitor C_{gs}^{cpw} under a high-frequency condition, that is, considering the fact that the coplanar waveguide effect of the AlGaN/GaN HEMT device will introduce additional parasitic capacitances, the working state and device characteristics of the AlGaN/GaN HEMT device can be reflected more accurately, and the accuracy of the device model is improved.

In one embodiment, the parasitic unit 120 further comprises a gate parasitic inductor L_{g}, a source parasitic inductor Lₛ, a drain parasitic inductor L_{d}, a gate parasitic resistor R_{g}, a source parasitic resistor Rₛ, a drain parasitic resistor R_{d}, a gate PAD parasitic capacitor C_{pg}, and a drain PAD parasitic capacitor C_{pd}. The first end a of the intrinsic unit 110 is connected with the gate terminal through the gate parasitic resistor R_{g} and the gate parasitic inductor L_{g}. The second end b of the intrinsic unit 110 is connected with the drain terminal through the drain parasitic inductor L_{d} and the drain parasitic resistor R_{d}. The third end c of the intrinsic unit 110 is connected with the source terminal through the source parasitic resistor Rₛ and the source parasitic inductor Lₛ. A first end of the first coplanar waveguide capacitor C_{gs}^{cpw} is connected with a common end of the gate parasitic resistor R_{g} and the gate parasitic inductor L_{g} and a second end of the first coplanar waveguide capacitor C_{gs}^{cpw} is connected with a common end of the source parasitic resistor Rₛ and the source parasitic inductor Lₛ. A first end of the second coplanar waveguide capacitor C_{gd}^{cpw} is connected with the first end of the first coplanar waveguide capacitor C_{gs}^{cpw}, and a second end of the second coplanar waveguide capacitor is connected with a common end of the drain parasitic resistor R_{d} and the drain parasitic inductor L_{d}. The gate PAD parasitic capacitor C_{pg} is connected in series between the gate terminal and the source terminal, and the drain PAD parasitic capacitor C_{pd} is connected in series between the drain terminal and the source terminal.

In one embodiment, the intrinsic unit 110 comprises a gate-source intrinsic capacitor C_{gs}, a gate-drain intrinsic capacitor C_{gd}, a drain-source intrinsic capacitor C_{ds}, an intrinsic channel resistor Rᵢ, a gate-drain leakage resistor R_{fd}, a gate-source leakage resistor R_{fs}, a drain-source resistor R_{ds}, a gate-drain resistor R_{gd}, and a transconductor gₘ. Wherein, the gate-source intrinsic capacitor C_{gs} and the intrinsic channel resistor Rᵢ are connected in series and then connected in parallel with the gate-source leakage resistor R_{fs} to form a first parallel circuit, a first end of the first parallel circuit is the first end a of the intrinsic unit 110, and a second end of the first parallel circuit is grounded. The gate-drain intrinsic capacitor C_{gd} is connected in parallel with the gate-drain leakage resistor R_{fd} and then connected in series with the gate-drain resistor R_{gd}, and one end, away from the gate-drain resistor R_{gd}, of the gate-drain intrinsic capacitor C_{gd} is connected with the first end of the first parallel circuit. The transconductor gₘ, the drain-source resistor R_{ds} and the drain-source intrinsic capacitor C_{ds} are connected in parallel to form a second parallel circuit, a first end of the second parallel circuit is connected with the gate-drain resistor R_{gd} and serves as the second end b of the intrinsic unit 110, and a second end of the second parallel circuit is grounded.

In one embodiment, an S parameter of the AlGaN/GaN HEMT device is measured using an IC-CAP system and a probe station, as shown in FIG. 4. Of course, the S parameter of the AlGaN/GaN HEMT device can also be measured in a vector network analyzer using a testing jig. Meanwhile, the AlGaN/GaN HEMT small-signal model is simulated in ADS, and the S parameter of the AlGaN/GaN HEMT small-signal model can also be acquired through simulation, as shown in FIG. 5. By comparing FIG. 4 with FIG. 5, it can be seen that the measured S parameter is basically the same as the simulated S parameter, that is, the AlGaN/GaN HEMT small-signal module additionally provided with the first coplanar waveguide capacitor C_{gs}^{cpw} between the gate and the source and the second coplanar waveguide capacitor C_{gd}^{cpw} between the gate and the drain can accurately reflect the working state of the AlGaN/GaN HEMT device, and the accuracy is greatly improved compared with the conventional small-signal module.

A method for extracting parameters of an AlGaN/GaN HEMT small-signal model mainly comprises the following steps of: firstly measuring the S parameter of the AlGaN/GaN HEMT device, converting the S parameter into a Y parameter and a Z parameter, and then extracting parasitic parameters such as parasitic capacitances, parasitic inductances, and parasitic resistances which are independent of bias, wherein the S parameter is called scattering parameter, the Y parameter is called admittance parameter, and the Z parameter is called impedance parameter. Then, intrinsic parameters are extracted by de-embedding a parasitic part of the S parameter. Therefore, the extraction accuracy of the intrinsic parameters directly depends on the extraction accuracy of the parasitic parameters, so the extraction accuracy of the parasitic parameters is particularly important.

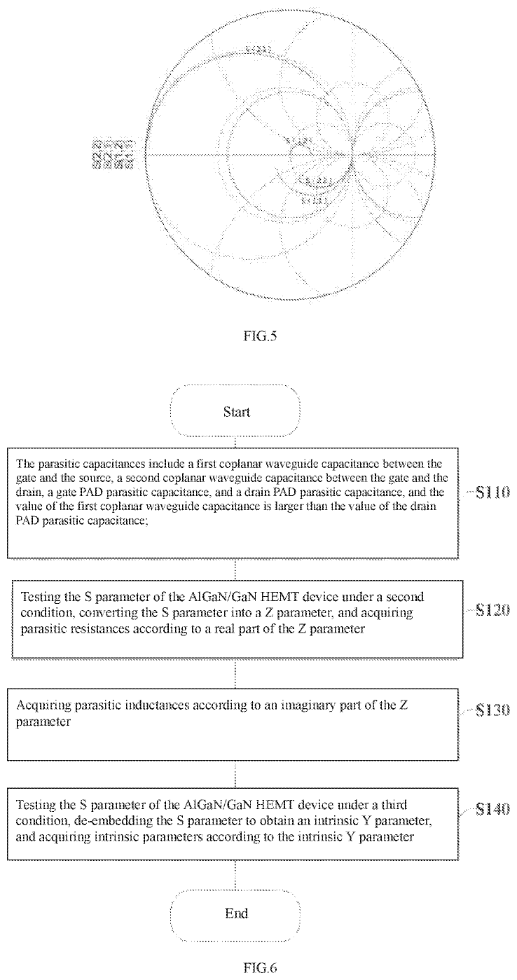

In one embodiment, the method for extracting the parameters of the AlGaN/GaN HEMT small-signal model specifically comprises the following steps, referring to FIG. 6.

S110, testing the S parameter of the AlGaN/GaN HEMT device under a first condition, converting the S parameter into the Y parameter, and acquiring the parasitic capacitances according to the Y parameter.

The parasitic capacitances include a first coplanar waveguide capacitance C_{gs}^{cpw} between the gate and the source, a second coplanar waveguide capacitances C_{gd}^{cpw} between the gate and the drain, a gate PAD parasitic capacitance C_{pg}, and a drain PAD parasitic capacitance C_{pd}. The gate PAD parasitic capacitance C_{pg} and the drain PAD parasitic capacitance C_{pd} are mainly parasitic effects between the metal of the gate terminal, the source terminal and the drain terminal and a substrate. The value of the first coplanar waveguide capacitance C_{gs}^{cpw} is larger than the value of the drain PAD parasitic capacitance C_{pd}.

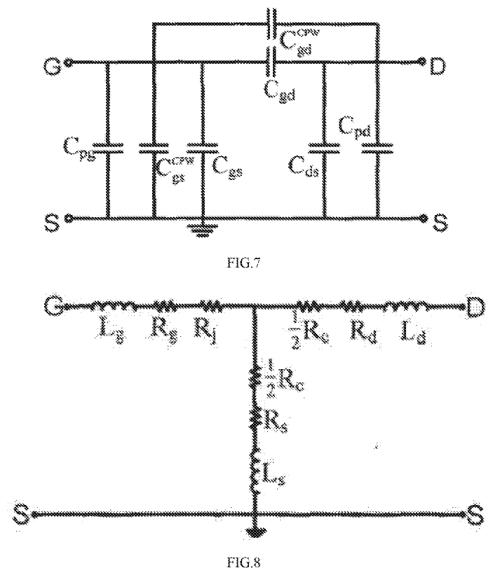

The first condition is a low-frequency test, V_{gs}<Vₚ, V_{ds}=0, and a channel of the AlGaN/GaN HEMT device is completely turned off. Wherein, V_{gs} represents gate-source voltage, Vₚ represents pinch-off voltage, and V_{ds} represents source-drain voltage. Since the channel of the device is completely turned off, the effect of the parasitic resistances can be ignored. Under the low-frequency test condition, the effect of the parasitic inductances can be ignored due to the small reactance of the parasitic inductances, an equivalent circuit thereof is shown in FIG. 7, and only parasitic capacitive elements are included in the equivalent circuit.

The S parameter is converted into the Y parameter according to the following formula:

Im(Y₁₁)=ω(C_{pg}+C_{gs}^{cpw}+C_{gs}+C_{gd}+C_{gd}^{cpw})

Im(Y₁₂)=−ω(C_{gd}+C_{gs}^{cpw})

Im(Y₂₂)=ω(C_{pd}+C_{ds}+C_{gd}+C_{gd}^{cpw})

wherein ω represents angular frequency, and due to the symmetry of the AlGaN/GaN HEMT device, it can be approximately considered that C_{gs}=C_{gd}, C_{gs}^{cpw}=C_{gd}^{cpw}. Since the PAD shapes and sizes of the gate and the source are almost the same, the gate PAD parasitic capacitance C_{pg} is equal to the drain PAD parasitic capacitance C_{pd}. Since the consensus capacitance of the AlGaN/GaN HEMT device is much larger than the PAD parasitic capacitance, it can also be considered here that the first coplanar waveguide capacitance C_{gs}^{cpw} is much larger than the PAD parasitic capacitance, and it can be approximately considered that C_{gs}^{cpw}=3C_{pd}. According to an imaginary part of the Y parameter, the values of the parasitic capacitances can be calculated respectively.

S120, testing the S parameter of the AlGaN/GaN HEMT device under a second condition, converting the S parameter into the Z parameter, and acquiring the parasitic resistances according to a real part of the Z parameter, wherein the parasitic resistances include a gate parasitic resistance R_{g}, a source parasitic resistance Rₛ and a drain parasitic resistance R_{d}.

The drain parasitic resistance R_{d} and the source parasitic resistance Rₛ respectively represent ohmic contact metal resistances of the drain terminal and the source terminal, and also include a bulk resistance diffused into an active region. The gate parasitic resistance R_{g} is mainly brought by schottky gate metal at the gate terminal. The parasitic resistances R_{g}, R_{d} and Rₛ sometimes change with the bias voltage, but the resistance values thereof are generally considered to be constant in small-signal models.

The second condition is that the channel of the AlGaN/GaN HEMT device is turned on under a high-frequency test condition, V_{gs}=Vₚ, V_{ds}=0, wherein V_{gs} represents gate-source voltage, Vₚ represents pinch-off voltage, and V_{ds} represents source-drain voltage. Under the high-frequency test condition, the intrinsic capacitance can be ignored, the device is on, the intrinsic resistance is very small, as the gate voltage increases, the gate differential resistance becomes smaller and smaller, thus the influence of parasitic gate capacitance can be ignored, and an equivalent circuit diagram as shown in FIG. 8 is obtained.

The S parameter is converted into the Z parameter according to the following formula:

Z₁₁=Rₛ+R_{g}+Rⱼ+½R_{c}+jω(Lₛ+L_{g})

Z₁₂=Z₂₁=Rₛ+½R_{c}+jωLₛ

Z₂₂=Rₛ+R_{d}+R_{c}++jω(Lₛ+L_{d});

wherein Rⱼ represents the sum of gate-drain leakage resistance R_{fd} and gate-source leakage resistance R_{fs}, and R_{c} represents the sum of channel resistances. When the device is in a cut-off region, the device has no current, Rⱼ and R_{c} can be ignored, and the Z parameter can be simplified as:

Z₁₁=Rₛ+R_{g}++jω(Lₛ+L_{g})

Z₁₂=Z₂₁=Rₛ++jωLₛ

Z₂₂=Rₛ+R_{d}+jω(Lₛ+L_{d})

The parasitic resistances are acquired according to the real part of the Z parameter.

R_{g}=Re(Z₁₁−Z₁₂)

R_{d}=Re(Z₂₂−Z₁₂)

Rₛ=Re(Z₁₂)=Re(Z₂₁)

S130, acquiring parasitic inductances according to an imaginary part of the Z parameter, wherein the parasitic inductances include a gate parasitic inductance L_{g}, a source parasitic inductance Lₛ and a drain parasitic inductance L_{d}.

The parasitic inductances L_{g}, L_{d} and Lₛ are mainly parasitic effects formed by metal on the surface of the device at the gate terminal, the drain terminal and the source terminal, and the parasitic inductances L_{g}, L_{d} and Lₛ have great influence on the performance of the device, especially under the high-frequency condition.

The parasitic inductances are acquired according to the imaginary part of the Z parameter.

L_{g}=Im(Z₁₁−Z₁₂)/ω

L_{d}=Im(Z₂₂−Z₁₂)/ω

Lₛ=Im(Z₁₂)/ω

Through the above method, the parasitic parameters of AlGaN/GaN HEMT can be acquired, as shown in Table 1.

TABLE 1
Parasitic parameters of coplanar waveguide
model of GaN HEMT device

| | | | |
|---|---|---|---|
| L_{g}/PH | 339.1 | R_{d}/Ω | 11.6 |
| L_{S}/PH | 1.7 | C_{pg}/fF | 42.1 |
| L_{d} PH | 55.9 | C_{pd}/fF | 6.4 |
| Rₛ/Ω | 29.5 | C_{gs}^{cpw}/fF | 18.3 |
| Rₛ/Ω | 7.6 | C_{gd}^{cpw}/fF | 52.3 |

Although there are certain errors between parameter extraction of the small-signal model and theoretically calculated parameters, the errors are related to errors of S parameter measurement, and are also related to simulation optimization. When measuring the S parameter, certain errors are also allowed, and when extracting parameters, approximate processing is carried out. During simulation verification in ADS, the model parameters are optimized and adjusted, and the final model parameters are subject to the parameters obtained after simulation.

S140, testing the S parameter of the AlGaN/GaN HEMT device under a third condition, de-embedding the S parameter to obtain an intrinsic Y parameter, and acquiring the intrinsic parameters according to the intrinsic Y parameter.

The intrinsic parameters include a gate-source intrinsic capacitance C_{gs}, a gate-drain intrinsic capacitance C_{gd}, a drain-source intrinsic capacitance C_{ds}, a transconductance gₘ, a transconductance delay factor τ, an intrinsic channel resistance Rᵢ, a gate-drain leakage resistance R_{fd}, a gate-source leakage resistance R_{fs}, a drain-source resistance R_{ds}, and a gate-drain resistance R_{gd}.

The gate-source intrinsic capacitance C_{gs} can be regarded as the sum of capacitances formed between the gate and the source and between the gate and the channel with a space charge region as a medium. Similarly, the gate-drain intrinsic capacitance C_{gd} is the sum of capacitances formed between the gate and the drain and between the gate and the channel. The drain-source intrinsic capacitance C_{ds} is used to characterize a coupling capacitance between source and drain electrodes. The transconductance gₘ is used to measure the variable of input gate-source voltage V_{gs} variation on output drain-source current I_{ds}. The physical parameter gives an internal gain of the device and is an important device index for measuring microwave and millimeter wave applications. The transconductance delay factor τ represents the time required for charges in a space charge region under the gate to redistribute from one steady state to another when V_{gs} changes. The intrinsic channel resistance Rᵢ is the resistance between the channel and the source.

The third condition is a forward bias condition of V_{gs}<0V, V_{ds}>0, wherein V_{gs} represents gate-source voltage, Vₚ represents pinch-off voltage, and V_{ds} represents source-drain voltage. In one embodiment, the S parameter measured under the condition of V_{gs}=−2V and V_{ds}=4V comprises the parasitic parameters and the intrinsic parameters, while the parasitic parameters have been obtained under the conditions of V_{gs}<Vₚ, V_{ds}=0 and V_{gs}=Vₚ and V_{ds}=0. The intrinsic Y parameter is obtained by de-embedding through conversion between the S parameter, Y parameter and Z parameter.

The intrinsic Y parameter is obtained by de-embedding the S parameter according to the following formula:

$${Y}_{11 i} = {G}_{fs} + {G}_{fd} + \frac{{ω}^{2} {R}_{i} {C}_{gs}^{2}}{{D}_{1}} + \frac{{ω}^{2} {R}_{gd} {C}_{gd}^{2}}{{D}_{2}} + j ω ( \frac{{C}_{gs}}{{D}_{1}} + \frac{{C}_{gd}}{{D}_{2}} )$$

$${Y}_{12 i} = - ( {G}_{fd} + \frac{{ω}^{2} {R}_{gd} {C}_{gd}^{2}}{{D}_{2}} + j ω \frac{{C}_{gd}}{{D}_{2}} )$$

$${Y}_{21 i} = - ( {G}_{fd} + \frac{{G}_{m} {e}^{- j ω τ}}{1 + j ω {R}_{i} {C}_{gs}} + j ω \frac{{C}_{gd}}{1 + j ω {R}_{gd} {C}_{gd}} )$$

$${Y}_{22 i} = {G}_{fd} + {G}_{ds} + \frac{{ω}^{2} {R}_{gd} {C}_{gd}^{2}}{{D}_{2}} + j ω ( {G}_{ds} + \frac{{C}_{gd}}{{D}_{2}} )$$

$$wherein {D}_{1} = 1 + {ω}^{2} {R}_{i} {C}_{gs}^{2} , \\ {D}_{2} = 1 + {ω}^{2} {R}_{gd}^{2} {C}_{gd}^{2} .$$

In the AlGaN/GaN HEMT device, conduction current between the gate and the source and between the gate and the drain can be equivalent to the existence of a schottky diode between the gate and the source and between the gate and the drain, and barriers to the conduction of gate current in the schottky diode are characterized by G_{fs} and G_{fd}, wherein

$${G}_{fs} = \frac{1}{{R}_{fs}} , \\ {G}_{fd} = \frac{1}{{R}_{fd}} .$$

Obviously, when the applied gate voltage is greater than the cut-in voltage of the diode, the schottky diode is turned on, and the values of R_{gsf} and R_{gdf} are smaller, while the values of G_{gsf} and G_{gdf} are larger.

According to the real and imaginary parts of the above-mentioned intrinsic Y parameter, 8 intrinsic parameters other than G_{fs} and G_{fd} can be obtained, refer to Table 2.

TABLE 2
Intrinsic parameters of coplanar waveguide model obtained
when V_{gs} = −2 V and V_{ds} = 4 V

| | | | |
|---|---|---|---|
| C_{gd}/fF | 42.2 | R_{ds}/kΩ | 49.8 |
| C_{gs}/fF | 99.3 | R_{gd}/Ω | 135.2 |
| C_{ds}/fF | 22.3 | RᵢΩ | 20.6 |
| R_{fd}/kΩ | 53.5 | gₘ/mS | 28.2 |
| R_{fs}/kΩ | 165.3 | τ/ps | 0.4 |

G_{fd} can be obtained through a Re(Y₁₂ᵢ)˜ω² curve, and G_{fs}+G_{fd} can be obtained through a Re(Y₁₁ᵢ)˜ω² curve, thus acquiring the values of G_{fs} and G_{fd}.

In one embodiment, the method further comprises the step of verifying the S parameter of the AlGaN/GaN HEMT device.

In one embodiment, an S parameter of the AlGaN/GaN HEMT device is measured using an IC-CAP system and a probe station, as shown in FIG. 4. Of course, the S parameter of the AlGaN/GaN HEMT device can also be measured in a vector network analyzer using a testing jig. Meanwhile, the AlGaN/GaN HEMT small-signal model is simulated in ADS within a frequency range is 200 MHz to 50 GHz, and the S parameter of the AlGaN/GaN HEMT small-signal model can also be obtained through simulation, as shown in FIG. 5. By comparing FIG. 4 with FIG. 5, it can be seen that the measured S parameter is basically the same as the simulated S parameter, that is, the AlGaN/GaN HEMT small-signal module additionally provided with the first coplanar waveguide capacitorcas between the gate and the source and the second coplanar waveguide capacitor w between the gate and the drain can accurately reflect the working state of the AlGaN/GaN HEMT device, and the accuracy is greatly improved compared with the conventional small-signal module.

The technical features of the above-described embodiments can be combined freely, and all possible combinations of the technical features in the above-described embodiments are not described for simplicity of description. However, as long as there is no contradiction between the combinations of these technical features, they should be considered within the scope of this specification.

The above-mentioned embodiments only describe several implementations of the present invention in a specific and detailed way, but it is not to be understood as limiting the scope of the invention. It should be noted that it is within the scope of the present invention for a person of ordinary skill in the art to make several modifications and improvements without departing from the concept of the present invention. Therefore, the scope of protection of the patent for the invention shall be subject to the appended claims.

What is claimed is:

1. An AlGaN/GaN HEMT small-signal model, comprising an intrinsic unit and a parasitic unit, wherein the parasitic unit comprises a first coplanar waveguide capacitor C_{gs}^{cpw} between a gate and a source and a second coplanar waveguide capacitor C_{gd}^{cpw} between the gate and a drain;
a first end of the intrinsic unit is connected with a gate terminal, a second end of the intrinsic unit is connected with a drain terminal, and a third end of the intrinsic unit is connected with a source terminal; and
the first coplanar waveguide capacitor C_{gs}^{cpw} is connected in series between the first end and the third end of the intrinsic unit, and the second coplanar waveguide capacitor C_{gd}^{cpw} is connected in series between the first end and the second end of the intrinsic unit.

2. The AlGaN/GaN HEMT small-signal model according to claim 1, wherein the parasitic unit further comprises a gate parasitic inductor L_{g}, a source parasitic inductor Lₛ, a drain parasitic inductor L_{d}, a gate parasitic resistor R_{g}, a source parasitic resistor Rₛ, a drain parasitic resistor R_{d}, a gate PAD parasitic capacitor C_{pg}, and a drain PAD parasitic capacitor C_{pd}; the first end of the intrinsic unit is connected with the gate terminal through the gate parasitic resistor R_{g} and the gate parasitic inductor L_{g}; the second end of the intrinsic unit is connected with the drain terminal through the drain parasitic resistor R_{d} and the drain parasitic inductor L_{d}; and the third end of the intrinsic unit is connected with the source terminal through the source parasitic resistor Rₛ and the source parasitic inductor Lₛ;
a first end of the first coplanar waveguide capacitor C_{gs}^{cpw} is connected with a common end of the gate parasitic resistor R_{g} and the gate parasitic inductor L_{g}; and a second end of the first coplanar waveguide capacitor C_{gs}^{cpw} is connected with a common end of the source parasitic resistor Rₛ and the source parasitic inductor Lₛ;
a first end of the second coplanar waveguide capacitor C_{gd}^{cpw} is connected with the first end of the first coplanar waveguide capacitor C_{gs}^{cpw}; and a second end of the second coplanar waveguide capacitor is connected with a common end of the drain parasitic resistor R_{d} and the drain parasitic inductor L_{d}; and
the gate PAD parasitic capacitor C_{pg} is connected in series between the gate terminal and the source terminal, and the drain PAD parasitic capacitor C_{pd} is connected in series between the drain terminal and the source terminal.

3. The AlGaN/GaN HEMT small-signal model according to claim 1, wherein the intrinsic unit comprises a gate-source intrinsic capacitor C_{gs}, a gate-drain intrinsic capacitor C_{gd}, a drain-source intrinsic capacitor C_{ds}, an intrinsic channel resistor Rᵢ, a gate-drain leakage resistor R_{fd}, a gate-source leakage resistor R_{fs}, a drain-source resistor R_{ds}, a gate-drain resistor R_{gd}, and a transconductor gₘ;
the gate-source intrinsic capacitor C_{gs} and the intrinsic channel resistor Rᵢ are connected in series and a combination of the gate-source intrinsic capacitor C_{gs} and the intrinsic channel resistor Rᵢ is connected in parallel with the gate-source leakage resistor R_{fs} to form a first parallel circuit, a first end of the first parallel circuit is the first end of the intrinsic unit, and a second end of the first parallel circuit is grounded;
the gate-drain intrinsic capacitor C_{gd} is connected in parallel with the gate-drain leakage resistor R_{fd} and a combination of the gate-drain intrinsic capacitor C_{gd} and the gate-drain leakage resistor R_{fd} is connected in series with the gate-drain resistor R_{gd}, and an end, away from the gate-drain resistor R_{gd}, of the gate-drain intrinsic capacitor C_{gd} is connected with the first end of the first parallel circuit; and
the transconductor gₘ, the drain-source resistor R_{ds} and the drain-source intrinsic capacitor C_{ds} are connected in parallel to form a second parallel circuit, a first end of the second parallel circuit is connected with the gate-drain resistor R_{gd} and serves as the second end of the intrinsic unit, and a second end of the second parallel circuit is grounded.

4. A method for extracting parameters of an AlGaN/GaN HEMT small-signal model, comprising:
testing an S parameter of an AlGaN/GaN HEMT device under a first condition, converting the S parameter into a Y parameter, and acquiring parasitic capacitances according to the Y parameter, wherein the parasitic capacitances include a first coplanar waveguide capacitance C_{gs}^{cpw} between a gate and a source, a second coplanar waveguide capacitance C_{gd}^{cpw} between the gate and a drain, a gate PAD parasitic capacitance C_{pg}, and a drain PAD parasitic capacitance C_{pd}, and a value of the first coplanar waveguide capacitance C_{gs}^{cpw} is larger than a value of the drain PAD parasitic capacitance C_{pd};
testing the S parameter of the AlGaN/GaN HEMT device under a second condition, converting the S parameter into a Z parameter, and acquiring parasitic resistances according to a real part of the Z parameter, wherein the parasitic resistances include a gate parasitic resistance R_{g}, a source parasitic resistance Rₛ and a drain parasitic resistance R_{d};
acquiring parasitic inductances according to an imaginary part of the Z parameter, wherein the parasitic inductances include a gate parasitic inductance L_{g}, a source parasitic inductance Lₛ and a drain parasitic inductance L_{d}; and
testing the S parameter of the AlGaN/GaN HEMT device under a third condition, de-embedding the S parameter to obtain an intrinsic Y parameter, and acquiring intrinsic parameters according to the intrinsic Y parameter, wherein the intrinsic parameters include a gate-source intrinsic capacitance C_{gs}, a gate-drain intrinsic capacitance C_{gd}, a drain-source intrinsic capacitance C_{ds}, a transconductance gₘ, a transconductance delay factor τ, an intrinsic channel resistance Rᵢ, a gate-drain leakage resistance R_{fd}, a gate-source leakage resistance R_{fs}, a drain-source resistance R_{ds}, and a gate-drain resistance R_{gd}.

5. The method according to claim 4, wherein the first condition is that a channel of the AlGaN/GaN HEMT device is completely turned off under a low-frequency test condition, V_{gs}<Vₚ, V_{ds}=0;
the second condition is that the channel of the AlGaN/GaN HEMT device is turned on under a high-frequency test condition, V_{gs}=Vₚ, V_{ds}=0; and
the third condition is a forward bias condition of V_{gs}<0V, V_{ds}>0, wherein
V_{gs} represents a gate-source voltage, Vₚ represents a pinch-off voltage, and V_{ds} represents a source-drain voltage.

6. The method according to claim 4, wherein the step of converting the S parameter into the Y parameter and acquiring the parasitic capacitances according to the Y parameter comprises:
converting the S parameter into the Y parameter according to the following formula:
Im(Y₁₁)=ω(C_{pg}+C_{gs}^{cpw}+C_{gs}+C_{gd}+C_{gd}^{cpw})
Im(Y₁₂)=−ω(C_{gd}+C_{gd}^{cpw})
Im(Yz₂₂)=ω(C_{pd}+C_{ds}+C_{gd}+C_{gd}^{cpw})
wherein ω represents an angular frequency, C_{gs}=C_{gd}, C_{gs}^{cpw}=3C_{pd}; and
acquiring the parasitic capacitances according to the Y parameter.

7. The method according to claim 4, wherein the step of converting the S parameter into the Z parameter, and acquiring the parasitic resistances according to the real part of the Z parameter comprises:
converting the S parameter into the Z parameter according to the following formula:
Z₁₁=Rₛ+R_{g}+Rⱼ+½R_{c}+jω(Lₛ+L_{g})
Z₁₂=Z₂₁=Rₛ+½R_{c}+jωLₛ
Z₂₂=Rₛ+R_{d}+R_{c}++jω(Lₛ+L_{d});
wherein Rⱼ represents a gate-drain leakage resistance R_{fd} and a gate-source leakage resistance R_{fs}, R_{c} represents a sum of channel resistances, ω represents an angular frequency, and Rⱼ and R_{c} are ignored when the device is in a cut-off region; and
acquiring the parasitic resistances according to the real part of the Z parameter.

8. The method according to claim 7, further comprising:
acquiring the parasitic inductances according to the imaginary part of the Z parameter.

9. The method according to claim 7, wherein the step of de-embedding the S parameter to obtain the intrinsic Y parameter and acquiring the intrinsic parameters according to the intrinsic Y parameter comprises:
obtaining the intrinsic Y parameter by de-embedding the S parameter according to the following formula:
$${Y}_{11 i} = {G}_{fs} + {G}_{fd} + \frac{{ω}^{2} {R}_{i} {C}_{gs}^{2}}{{D}_{1}} + \frac{{ω}^{2} {R}_{gd} {C}_{gd}^{2}}{{D}_{2}} + j ω ( \frac{{C}_{gs}}{{D}_{1}} + \frac{{C}_{gd}}{{D}_{2}} )$$
$${Y}_{12 i} = - ( {G}_{fd} + \frac{{ω}^{2} {R}_{gd} {C}_{gd}^{2}}{{D}_{2}} + j ω \frac{{C}_{gd}}{{D}_{2}} )$$
$${Y}_{21 i} = - ( {G}_{fd} + \frac{{G}_{m} {e}^{- j ω τ}}{1 + j ω {R}_{i} {C}_{gs}} + j ω \frac{{C}_{gd}}{1 + j ω {R}_{gd} {C}_{gd}} )$$
$${Y}_{22 i} = {G}_{fd} + {G}_{ds} + \frac{{ω}^{2} {R}_{gd} {C}_{gd}^{2}}{{D}_{2}} + j ω ( {G}_{ds} + \frac{{C}_{gd}}{{D}_{2}} )$$
$$wherein {D}_{1} = 1 + {ω}^{2} {R}_{i} {C}_{gs}^{2} , \\ {D}_{2} = 1 + {ω}^{2} {R}_{gd}^{2} {C}_{gd}^{2} , \\ {G}_{fs} = \frac{1}{{R}_{fs}} , \\ {G}_{fd} = \frac{1}{{R}_{fd}} ,$$
and ω represents an angular frequency; and
acquiring the intrinsic parameters according to a real part and an imaginary part of the intrinsic Y parameter.

10. The method according to claim 9, further comprising:
verifying the S parameter of the AlGaN/GaN HEMT device.
